(19) United States
(12) Patent Application Publication
(10) Pub. No.: US 2019/0255753 A1
(43) Pub. Date: Aug. 22, 2019

(54) METHOD AND DEVICE FOR PRODUCING PLASTIC PROFILES

(71) Applicant: Siegfried PRAMBERGER, Vorchdorf (AT)

(72) Inventor: Siegfried PRAMBERGER, Vorchdorf (AT)

(21) Appl. No.: 16/343,336

(22) PCT Filed: Oct. 19, 2017
(86) PCT No.: PCT/AT2017/060274

§ 371 Date: Apr. 18, 2019

(30) Foreign Application Priority Data
Oct. 19, 2016 (AT) A 50948/2016

(51) Int. Cl. B29C 48/90; B29C 48/00; B29C 48/09; B29C 48/92

(52) U.S. Cl. CPC B29C 48/904; B29C 48/0022; B29C 48/09; B29C 2948/92704; B29C 48/905; B29C 2948/9218; B29C 2948/92152; B29C 48/92

(57) ABSTRACT

The invention relates to a method for producing plastic profiles, according to which a starting material is plasticated and formed in an extruder, then is cooled and calibrated in at least one dry calibration unit and at least one calibration tank and is subsequently subdivided into individual profile sections. To achieve optimal control of the extrusion line, measurements relating to the geometry and/or the weight of the plastic profile are continuously carried out downstream of the calibration tank and correction values, which are used to change settings in the extruder, the dry calibration unit and/or the calibration tank, are calculated directly from these measured values.

The invention relates to a method for producing plastic profiles, in which a starting material is plasticized and formed in an extruder, then cooled and calibrated in at least one dry calibration unit and at least one calibration tank, and then subdivided into individual profile sections.

Plastic profiles are produced in extrusion lines in which an extruder first pushes out an initially hot and plastically deformable profile strand, which is then processed in calibration tools into a plastic profile with precisely defined geometric properties. The adjustment of such an extrusion line is very time-consuming as a large number of parameters have to be defined for the individual tools. These parameters interact in a complex way to produce a product with certain properties. The operation of such extrusion lines requires qualified personnel in order to keep waste to a minimum. However, it is often the case that slightly altered environmental conditions cause undesirable characteristics of the plastic profile produced, so that large quantities of faulty plastic profiles may be produced if the need for improved adjustment is not immediately noticed and appropriate corrective action is not taken.

A challenge when operating an extrusion line is to always meet all minimum requirements for profile quality and geometry, while at the same time minimizing the total weight of the plastic profile in order to avoid unnecessary material costs.

It is the object of the present invention to specify a method which enables it to automate an extrusion line to a large extent and thus to produce it independently of the constant presence of qualified personnel.

According to the invention, this is solved in that measurements which relate to the geometry and/or the weight of the plastic profile are continuously carried out downstream of the calibration tank and that correction values are calculated directly from these measured values which are used to change settings in the extruder, the dry calibration unit and/or the calibration tank.

It is important in the context of the invention that any deviations from the desired optimum condition are detected reliably and quickly, and that the necessary measures in order to approach the optimum condition are determined immediately and automatically.

It is preferably provided that a measurement consists of weighing the profile sections immediately after separation from the profile strand. The profile sections are weighed on the tilting table immediately after the saw or guillotine, which typically subdivides the endless profile strand into 6 m long profile sections. Since the weighing process is carried out in the period after a first profile section has been placed on the tilting table and before the next one reaches the tilting table, the production process is not impaired in any way by the measuring process. It is particularly advantageous that the weight is measured at the earliest possible time, so that dead times can be minimized.

A significant improvement in automation can be achieved by measuring the pull-off force required to move the plastic profile through the processing line. The caterpillar pull-off must exert a tensile force on the profile strand that is sufficient to overcome the resistances in the calibration tools. These resistances depend, among other things, on the temperature of the profile strand in the tools and on the geometry of the profile strand. In this way, information about the conditions in the calibration tool can be derived practically in real time, which can be taken into account when regulating certain parameters.

Another possibility to obtain information is that the determination of the thickness of at least one wall section of the profile sections is used as a measurement. This measurement can preferably be carried out optically by photographically evaluating the end face of the profile strand resulting from the cutting of the profile sections. However, other measuring methods, such as ultrasonic measurements, can also be used to determine the thickness.

Further measurements can relate to the surface quality, i.e. gloss or scratches and the color of the plastic profile.

The extrusion speed can preferably be used as the correction value. When the speed of the caterpillar pull-off is increased, the wall thickness of the plastic profile decreases, while at lower speed and under certain circumstances problems with waviness can be observed.

A particularly differentiated possibility of influencing the profile quality can be achieved in that a correction value concerns the selective cooling of parts of the profile cross-section in the area of the extrusion die. In this way, a large number of areas of the profile cross-section can be influenced in thermal terms independently of each other. In particular, this prevents the wall thickness of the plastic profile in these areas. Cooling can be achieved by locally controlled inflation of air at the outlet of the plastic profile from the extrusion die.

Another preferred way of influencing this is to use the control of the cooling water flow in individual sections of the dry calibration unit as a correction value. By changing the heat dissipation in the dry calibration unit, further possibilities for influence are made available. A particularly efficient influence can be achieved by independently controlling the cooling water flow in at least two different circuits. For example, visible surfaces of the plastic profile on the one hand and extremities of the plastic profile on the other hand can be subjected to cooling independently of each other in the dry calibration unit.

Similarly, it may be provided that a correction value relates to the control of the cooling water flow in at least one section of the calibration tank. Here, too, it is possible to achieve targeted control by subdividing the cooling water flow into at least two different circuits, which are controlled independently.

It turned out to be particularly favorable if the flow direction of the cooling water in at least one cooling circuit could be reversed. This means that in a dry calibration unit, for example, the cooling water can be fed selectively through the cooling circuit in both directions. The switchover can be switched periodically, for example after every 3 minutes, or when it is determined that a blockage may have occurred due to an increase in the back pressure in the cooling water circuit. If the back pressure exceeds a certain level, a changeover is initiated. Such a measure is particularly possible in the case of the solution according to the invention if several cooling water circuits are present in a tool, by means of which a direct response behavior is provided. The temperature differences at the beginning and end of the cycle are also small, so that the changeover does not bring about any significant change in temperature conditions.

The position of the calibration table is also measured continuously and correction values are calculated to adjust height, side position and longitudinal position. The current position can be displayed digitally on the terminal in order to carry out a calibration with reference points.

Any obstacles to changing the position of the calibration table should be detected and taken into account by safety systems. This concerns the space between extruder and calibration table and the space between calibration table and caterpillar pull-off.

The present invention also relates to a device for the production of plastic profiles in an extrusion line consisting of several tools, in which at least one dry calibration unit and at least one calibration tank arranged on a calibration table are provided downstream of an extruder.

This device is characterized according to the invention in that a control device is provided which is connected on the one hand to sensors and on the other hand to actuators which modify the setting parameters of tools of the extrusion line.

A sensor designed as a scale is particularly preferred, which is provided downstream of a cutting device in order to weigh the severed profile sections. The weight of the plastic profile is essential global information that is important for the control of the extrusion line.

In addition or alternatively, a sensor can be designed to determine the wall thickness in individual areas of the plastic profile.

A particularly favorable embodiment variant of the present invention provides that at least one die plate is arranged at the end face of the extrusion die in order to selectively direct air towards predetermined areas of the plastic profile or the outlet area of the plastic profile on the extrusion line. In particular, several die plates can be arranged around the circumference of the plastic profile. In this way, the plastic profile can be cooled locally on a particularly fine scale before it enters the calibration tools. Alternatively, the die plate can be located on one face of a dry calibration unit.

Particularly efficient assembly and easy capability for modification are achieved when the die plate is magnetically attached to the extrusion line or dry calibration unit. In order to enable a repeatable exact positioning of the die plate, grooves, projections etc. can be provided on the respective front side to ensure a certain position of the die plate. A particular advantage of magnetic fixation is the fact that the die plate can be mounted, dismounted or repositioned while the extrusion line is in operation, if the distance between the extrusion line and the first dry calibration unit is typically very small. This means that the calibration table does not have to be moved if the die plate is manipulated.

In the following, the present invention will be explained in more detail on the basis of the embodiment variants depicted in the figures, wherein:

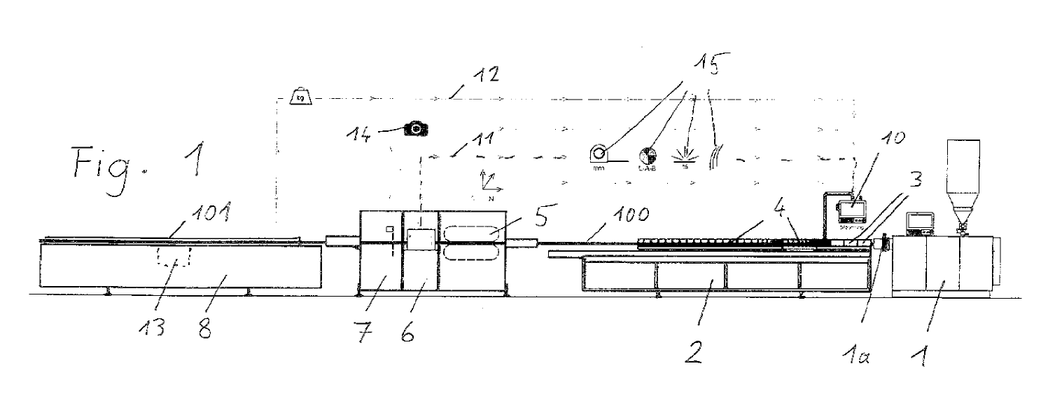

FIG. 1 schematically shows an extrusion line according to invention;

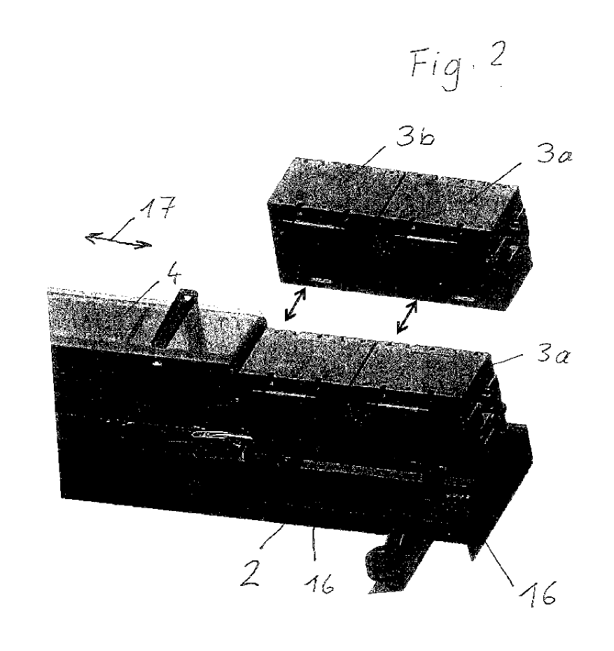

FIG. 2 shows a detail of a calibration table including a dry calibration unit in an oblique view;

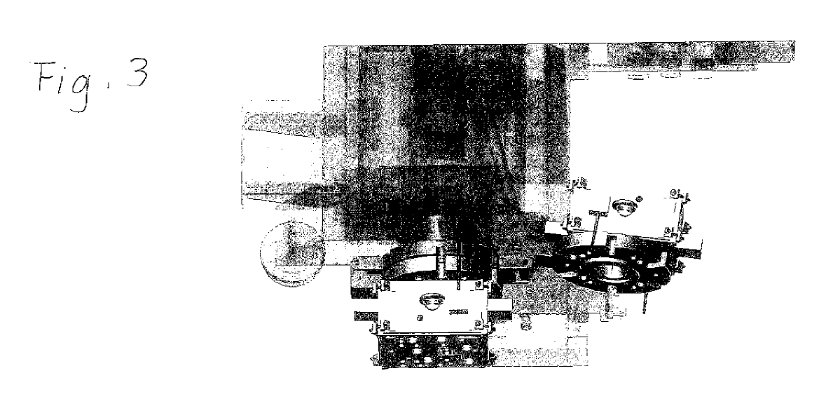

FIG. 3 shows a detail of an extrusion die;

FIG. 4 shows a front view of a dry calibration unit;

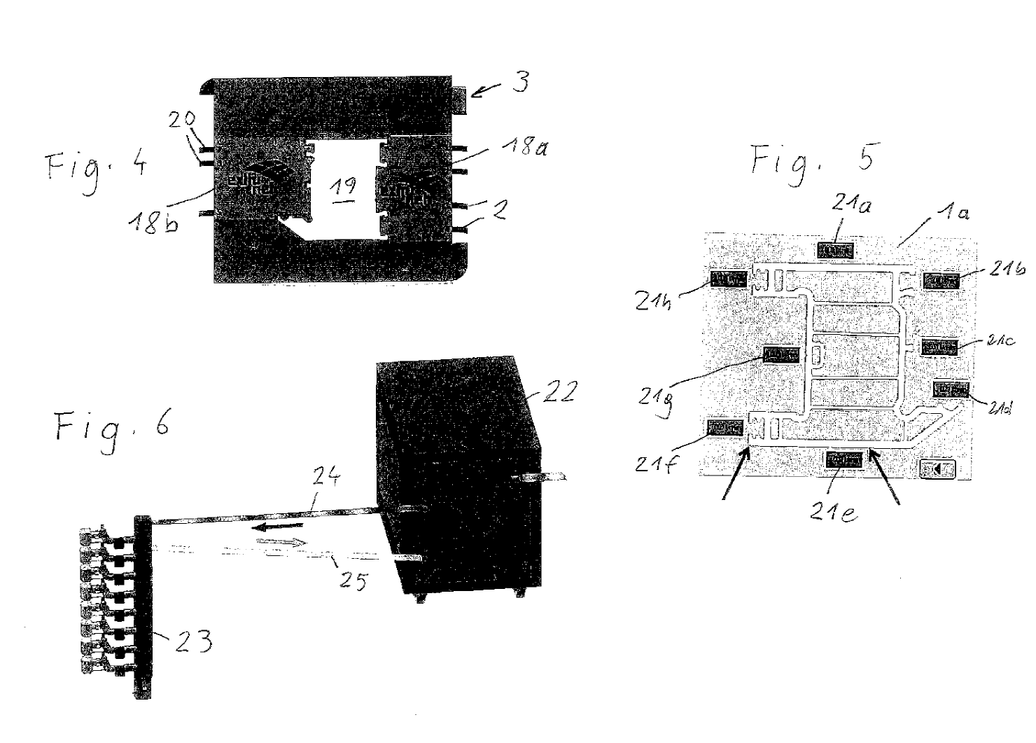

FIG. 5 shows a front view of an extrusion die;

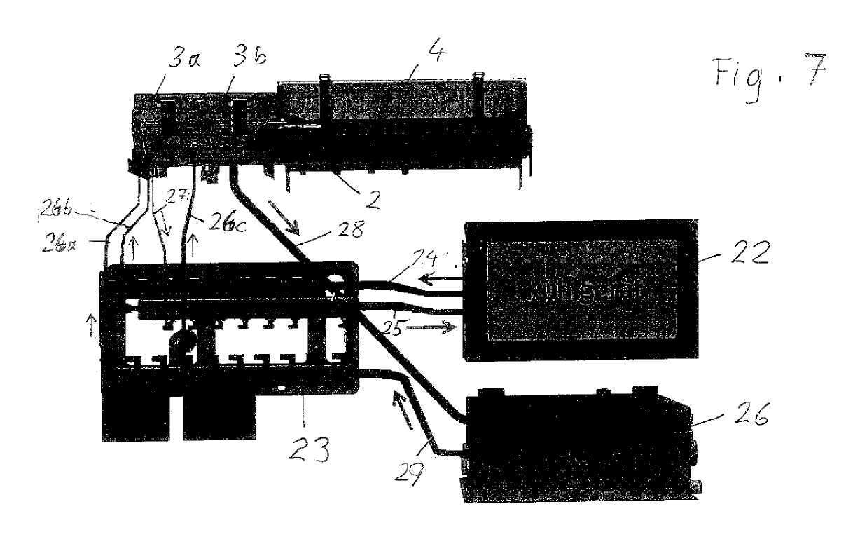

FIG. 6 schematically shows a cooling unit installed in the calibration table; and

FIG. 7 schematically shows the guidance of water in the calibration table and the calibration tools.

The extrusion line of FIG. 1 consists of an extruder 1 with an extrusion die 1a, a calibration table 2 which is arranged downstream thereof and on which several dry calibration units 3 and several calibration tanks 4 (i.e. the calibration tools) are arranged to cool and calibrate the plastic profile 100 ejected from the extruder 1.

The calibration tanks 4 can be moved longitudinally on the calibration table 2 to allow quick adaptation to a different number of dry calibration units 3, as it is desirable that the calibration tanks 4 connect directly to the dry calibration units 3.

Subsequently, the plastic profile 100 is fed into a caterpillar pull-off 5, which provides the necessary tensile forces to pull the plastic profile 100 through the calibration tools. In a measuring station 6, the plastic profile 100 is measured and then cut in a saw 7 into profile sections 101, which are deposited on a tilting table 8.

The extrusion line is controlled by a control unit 10, which is connected to the individual components of the extrusion line via control lines 11, 12. Schematically, a scale 13 is indicated in the tilting table 8, which determines the weight of each profile section 101 and transmits it to the control unit 10.

In the same way, the data about the profile geometry and the like are output from the measuring station 6 to the control unit 10. With reference numeral 15, the nature of this data is indicated, namely geometric measurements, color, gloss and scratches. In addition, all relevant data of the other components are transmitted in a way not described here, such as the pull-off force applied by the caterpillar pull-off 5, measured values of pressure and temperature from the calibration tools, etc., and above all identification data with which each tool can be uniquely identified.

During ongoing operation of the extrusion line, the control unit 10 not only accepts data and issues control commands in order to optimally manage the extrusion process, but also records them in a database in order to gain empirical values for subsequent extrusion processes.

FIG. 2 shows that the dry calibration units 3a, 3b can easily be mounted on the calibration table 2, since only one mechanical connection via quick-release fasteners 16 has to be established. All connections are provided on the contact surface on the underside of the dry calibration units 3a, 3b, which is not visible here. They interact with connections at the mounting positions of the calibration table 2 that are also not visible here. Therefore, no hoses are required to connect the calibration tools 3a, 3b, 4 to the calibration table 2, which minimizes the risk of mix-ups or errors.

It is also possible within the scope of the invention to continue to use existing calibration equipment in an extrusion line designed in accordance with the invention. A base plate is firmly attached to the underside of these tools, which has the necessary connections on its underside and connects laterally to other connections via internal connecting lines. These additional connections are then connected via connecting hoses to the typically side-mounted connections of conventional calibration tools. The original tool then forms a unit with the floor plate and the connecting hoses, which is also no longer separated during dismantling and assembly of the tool. For the purposes of the present invention, this unit is regarded as a calibration tool. Again, there is no danger of mix-ups, as there is no further manipulation of the connecting hoses after the initial installation.

FIG. 3 shows a quick-change system for the extrusion die 1a, which can be folded away sideways. Quick-connect closures combined with preheating of the extrusion die 1a allow an extremely short cycle time of less than 10 minutes when changing the extrusion die 1a.

FIG. 4 shows the end face of a dry calibration unit 3, wherein the one die plate 18a, 18b is magnetically fixed on both sides of the opening 19, through which the plastic profile 100 passes. Several dies not visible here can be supplied with compressed air via connections 20 in order to selectively cool the plastic profile 100 entering the opening 19. The air volume is measured to create reproducible conditions. In this way, the wall thickness can be individually adjusted to the outer areas of the plastic profile 100, and the weight of the manufactured plastic profile can be precisely regulated (meter weight).

A similar solution is shown in FIG. 4, in which eight die plates 21a, 21b, 21c, 21d, 21e, 21f, 21g and 21h are mounted magnetically on the face of an extruder die 1a. The die plates 21a and 21e are aimed at visible surfaces of the plastic profile 100, while the die plates 21b, 21c, 21d, 21f and 21h are aimed at extremities, which are always a challenge in extrusion processes.

FIG. 6 shows a cooling device arranged in calibration table 2, which cools the general cooling water, which is made available to the extrusion line from the outside, to a lower temperature of 5° C. to 8° C., for example. A distributor 23 is supplied via a flow line 24 and a return line 25, which are used to supply special cooling circuits in the calibration tools.

FIG. 7 shows the general cooling water guidance for the dry calibration units 3a, 3b. The distributor 23 is supplied with general cooling water via a supply line 29 via a water tank 26. In addition, the cooling unit 22 supplies low temperature water as shown above.

General cooling water at a first pressure level is fed to certain circuits in the dry calibration units 3a, 3b via a first supply line 26a with a small cross-section. A second supply line 26b with a small cross-section leads cooling water of low temperature to further circuits. General cooling water at a further pressure level is supplied via a third supply line 26c with a large cross-section. Return lines 27, 28 return the used cooling water.

1. A method for producing plastic profiles comprising the following steps:
plasticizing and forming a starting material in an extruder to form a plastic profile;
cooling and calibrating the plastic profile in at least one dry calibration unit and at least one calibration tank; and
subdividing the plastic profile into individual profile sections;
continuously measuring the geometry and/or the weight of the plastic profile downstream of the calibration tank; and
calculating directly from the measured values correction values, which are used to change settings in the extruder, the at least one dry calibration unit and/or the at least one calibration tank.

2. The method according to claim 1, characterized in that a measurement consists of the weighing of the profile sections immediately after separation from a profile strand.

3. The method according to claim 1, characterized in that a measurement consists of determining a pull-off force required to convey the plastic profile through a processing line.

4. The method according to claim 1, characterized in that a measurement consists of determining a thickness of at least one wall section of the individual profile sections.

5. The method according to one of claim 1, characterized in that the correction value relates to an extrusion speed.

6. The method according to claim 1, characterized in that a correction value relates to selectively cooling the individual profile sections in a region of an extrusion die.

7. The method according to claim 6, characterized in that cooling of the plastic profile takes place by locally controlled inflation of air at an outlet of the plastic profile from the extrusion die.

8. The method according to claim 1, characterized in that a correction value relates to control of a cooling water flow in individual sections of the at least one dry calibration unit.

9. The method according to claim 8, characterized in that the cooling water flow in individual sections of the at least one dry calibration unit is independently controlled by at least two different circuits.

10. The method according to claim 1, characterized in that a correction value relates to control of a cooling water flow in at least one section of the at least one calibration tank.

11. The method according to claim 10, characterized in that the cooling water flow is independently controlled by at least two different circuits.

12. The method according to claim 1, characterized in that the flow direction of the cooling water in at least one circuit of the at least two different circuits is reversable.

13. The method according to claim 1, further including continuously measuring a position of a calibration table and calculating correction values in order to adjust height, side position and longitudinal position of the calibration table.

14. The method according to claim 13, further including detecting and accounting for obstacles while changing the position of the calibration table by safety systems.

15. A system for producing plastic profiles in an extrusion line, the system comprising:
a plurality of tools including at least one dry calibration unit and at least one calibration tank;
a calibration table;
an extruder;
sensors;
actuators which alter the setting parameters of the plurality of tools; and
a control device communicatively connected to the sensors and the actuators;
wherein the plurality of tools are provided downstream of the extruder.

16. The system according to claim 15, characterized in that one of the sensors is a scale, provided downstream of a cutting device, for weighing separated profile sections.

17. The system according to claim 15, characterized in that one of the sensors is adapted to determine the wall thickness in individual regions of the plastic profile.

18. The system according to claim 15, further including at least one die plate arranged at an end face of an extrusion die, the at least one die plate configured and arranged to selectively direct air onto predetermined regions of the plastic profile or an outlet region of the plastic profile at the extrusion line.

19. The system according to claim 15, further including at least one die plate is arranged on an end face of a dry calibration unit, the at least one die plate configured and arranged to selectively direct air onto predetermined regions of the plastic profile or an outlet region of the plastic profile at the extrusion line.

20. The system according to claim 18 , characterized in that the at least one die plate is magnetically attached to the extrusion die.

21. The system according to claim 15, further including a positioning device configured and arranged to adjust the height, side position and longitudinal position of the calibration table.
